(19) United States
(12) Patent Application Publication
(10) Pub. No.: US 2017/0013384 A1
(43) Pub. Date: Jan. 12, 2017

(54) REMOTE CONTROL AND AUDIO A2DP FOR A SHORT DISTANCE WIRELESS COMMUNICATION DEVICE

(71) Applicants: ARTHUR F. SEYMOUR, Wheeling, IL (US); James Paul Seymour, Wheeling, IL (US)

(72) Inventors: ARTHUR F. SEYMOUR, Wheeling, IL (US); James Paul Seymour, Wheeling, IL (US)

(21) Appl. No.: 15/197,983

(22) Filed: Jun. 30, 2016

Related U.S. Application Data
(60) Provisional application No. 62/191,450, filed on Jul. 12, 2015.

(51) Int. Cl. H04S 1/00; G08C 17/02

(52) U.S. Cl. CPC H04S 1/00; G08C 17/02

(57) ABSTRACT

A system that enhances upon current stereo audio wireless transmission/reception solutions by converting stereo audio to monaural audio and adding remote control functionality configured to appear as audio thus eliminating the need for additional digital wireless channels or resources. Namely—Audio plus Remote Control System (ARCS).

### CROSS REFERENCE TO RELATED APPLICATION

The following application is a based on and claims the priority benefit of U.S. Provisional Application Ser. No.: 62/191,450 filed on Jul. 12, 2015 currently co-pending; the entire contents of which are incorporated by reference.

### FIELD OF THE INVENTION

The present device generally relates to a method for supporting the wireless transmission and reception of audio and low bit rate remote control data simultaneously over a wireless link designed only for stereo audio.

### BACKGROUND OF THE INVENTION

Remote control products that exist on the market today often use wireless signals to control motion, lights, or pre-recorded sounds. Wireless technology also exists that provides non-interfering, high quality transmission of stereo audio to headsets or speakers. A stereo audio signal consists of a Left audio signal and a Right audio signal. The wireless transmission of a stereo audio signal thus requires the wireless link to provide two logical channels and twice the wireless resources to transmit two separate audio signals. One logical channel plus wireless resources is used to transmit the Left audio signal to the headset or speaker and another logical channel plus wireless resources is used to transmit the Right audio signal to the headset or speaker. The present method converts the stereo audio signal source to a monaural audio signal source by adding/combining the Left and Right audio signals together, which can then be transmitted on a single logical channel, therein freeing up the other logical channel for transmission of other functions such as motion control signals.

Note that the monaural audio signal (also referred to as the “Left+Right” audio signal) is typically of the same bandwidth as the initial individual Left or Right audio signals, which therefor allows it to be transmitted over a single logical channel (of the same maximum bandwidth) plus a single set of wireless resources. This then allows for a remote control source signal to be transmitted over the second logical channel plus second set of wireless resources. The present method may therein eliminate all the overhead which would normally be associated with providing additional logical channels (i.e. at least a third logical channel) and wireless resources required to transmit a remote control signal simultaneously with stereo audio signals. For most devices, the loss of stereo audio is often not important since many remote controlled products have only one speaker and no stereo headset jacks.

### SUMMARY OF THE INVENTION

Utilizing the present method, one example of a remote controlled product which receives wireless audio input and wireless non-audio input might be a speaker which utilizes Bluetooth® technology. In particular, a Bluetooth® device may send both wireless audio signals and wireless non-audio signals simultaneously through a wireless remote control to not only provide audio data to a speaker circuit, but also to, for example, instruct the speaker circuit to mute, or to increase or decrease in volume, or to turn the speaker to face a different direction. Another example of use of the present method might be use by a wireless remote control which sends not only music to a remote controlled toy (such as a radio controlled car) but also simultaneously sends non-audio data to control the movement of the radio controlled toy. Yet another application of the present method might be the simultaneous programming of a device without interrupting music which is playing.

Bluetooth® specifications, however, were designed to support the wireless transmission/reception of stereo audio using one profile (e.g. Advanced Audio Distribution Profile or “A2DP”) and remote control data using a second and separate profile, for example, Audio/Video Remote Control Profile (or “AVRCP”) or Serial Port Profile (or “SPP”). The AVRCP and SPP profiles define additional protocols which may be used to send low bit rate remote control data; however, this requires these protocols to be implemented in the devices along with the A2DP profile. The complexity and cost of the device are increased as a result of this previous method. In particular, the complexity and cost are increased as a result of the device needing to consume more wireless resources to both transmit the audio and non-audio data simultaneously.

There are some Bluetooth® devices which simultaneously support the transmission/reception of wireless audio and wireless remote (or “non-audio”) control data. Wireless earphones, for example, often have buttons for adjusting the volume of a mobile device or changing tracks on the mobile device. These devices use the A2DP Bluetooth® profile to transmit/receive the stereo audio signals while at the same time use the AVRCP Bluetooth® profile to transmit/receive the non-audio remote control commands to adjust volume or change tracks. Similarly, current remote control cars which support audio from the mobile device to be played (e.g. as the radio of the car) typically use the A2DP Bluetooth® profile to transmit/receive the audio signal and use the SPP Bluetooth® profile to transmit/receive the remote control commands to control the car. The use of multiple Bluetooth® profiles to support the transmission of both stereo audio and remote control data increases the cost of the Bluetooth® solution and often even requires multiple Bluetooth® chips. Further, the use of multiple Bluetooth® profiles for transmission of both the audio and remote control data therein reduces the flexibility of the solution since Bluetooth® chips supporting profiles such as AVRCP have been designed to support the specific Audio/Video remote control commands, and thus are difficult to use as general remote control commands for other applications.

Using the present method, Audio plus Remote Control System (ARCS), addresses these issues by using a single Bluetooth® profile (A2DP) to simultaneously transmit and receive both an audio signal and low bit rate remote control data commands. A2DP defines the protocols and procedures that realize distribution of audio content of high-quality stereo on two separate Asynchronous Connectionless (ACL) channels. One ACL channel may be used to transmit the Left audio signal and the other ACL channel may be used to transmit the Right audio signal. The present method consists of combining the Left and Right channel audio signals of the stereo audio source to create a single monaural audio signal (Left+Right audio signal). This monaural audio signal would be transmitted over the Bluetooth® A2DP profile as, for example, the Left audio channel using one ACL channel, thus freeing up the Right audio ACL channel to send low bit rate remote control data. Note that as long as the bit rate of the remote control signal is within the audio range supported by the A2DP profile (20 Hz to 20 kHz), the remote control signal may be transmitted without distortion.

### BRIEF DESCRIPTION OF FIGURES

FIG. 1 illustrates the setup of a typical wireless system for transporting stereo audio signals plus a low bit rate remote control signal.

FIG. 2 illustrates the setup of the wireless system for the current invention for transporting audio plus a low bit rate remote control signal.

FIG. 3 illustrates details on how left 308 and right 307 signals from an audio source 300 are added in an audio combiner 305 to produce a monaural L+R 313 signal.

FIG. 4 illustrates details on how signals from digital sources 400 are converted to proper Bluetooth® levels by a digital to audio level converter 401.

FIG. 5 illustrates details for converting a remote control audio level signal 502 from any audio level output to a digital signal 504.

FIG. 6 illustrates how low bit rate audio signals 502 that have been converted to serial digital level signals 504 can be stored as an 8 bit byte to produce 256 possible different combinations.

### DETAILED DESCRIPTION OF THE PREFERRED EMBODIMENT

Stereophonic sound (or “stereo”) is a method of reproducing sound which creates the illusion of directionality and audible perspective. This is achieved by using two or more independent audio channels through a configuration of two or more loudspeakers (or stereo headphones) in such a way as to create the impression of sound heard from various directions. Monophonic (or “mono” sound) is where audio is in the form of one channel which is sent to a single loudspeaker. Stereo sound is now very common in many audio systems such as radio, TV, recorded music, and movie theaters. The physics of sound dictates that we'll never hear 100% stereo separation in any room because longer audio waves will always “wrap around” the listener's head and have less perceived separation than higher frequencies. This is why we're able to get away with a single subwoofer in an otherwise stereo speaker setup. Typical amplifier R-L separation in today's electronics is 60 dB and with digital Bluetooth® can be as high as 90 dB or better.

In today's US market a radio controlled device many times will use radio frequencies in the 27 or 49 megahertz (MHz) bands. These radio frequencies are used by controllers to communicate with devices. Running your device alongside or near other similar devices will usually result in interference. The radio signals get mixed up. One controller will try to control both vehicles or the user may obtain erratic behavior in one or both devices. To operate in close proximity, the user must make sure each device is on a different frequency. For example, a 27 MHz and a 49 MHz device may run alongside each other with no interference problem.

Most fixed frequency 27 MHz devices use the specific frequency of 27.145 MHz (Channel 4). However, some devices have band selectable frequencies. This allows the user to select a narrow portion or band of the frequency to use. Typically the band selectable devices will have a channel switch on both the device and the controller that changes between two and up to six bands or channels. In this way, two 27 MHz band selectable devices can operate in the same area if each device in the corresponding controller is set to a different channel.

Bluetooth® is a short-range wireless technology designed for personal area networks which uses the 2.4 to 2.485 GHz bands. The core of this radio technology is that it uses a frequency-hopping spread spectrum signal 103 that bounces between 79 different frequencies, which makes it less prone to narrowband interference from other 2.4 GHz devices in the same geographic area, and provides interference averaging benefits between Bluetooth® devices. The standard has three different classes of strength, using more power to farther. Class 1 may stretch out up to 100 meters from the controller and is usually reliable up to 30 meters even in an unfriendly environment.

Bluetooth® utilizes a series of profiles. In particular, Bluetooth® devices need to have compatible profiles in order to connect to each other. For instance, the Advanced Audio Distribution (A2DP) profile describes how to wirelessly transmit a stereo audio stream from an audio source 100 to a left speaker 105 and a right speaker 106. A2DP is used mostly in simple stereo headsets. To add a low bit rate remote control source 101 for controlling a remote controlled device 107 you must use another profile like Audio/Video Remote Control Profile (AVRCP) for both transmitter 102 and receiver 104, which is more complex and increases cost.

Creating a Bluetooth® connection between the A2DP transmitter 203 and A2DP receiver 205 is a multi-step process involving three progressive states:
1. Inquiry—If two Bluetooth® devices know absolutely nothing about each other, one must run an inquiry to try to discover the other. One device sends out the inquiry request, and any device listening for such a request will respond with its address, and possibly its name and other information.
2. Paging (Connecting)—Paging is the process of forming a connection between two Bluetooth® devices. Before this connection may be initiated, each device needs to know the address of the other (found in the inquiry process).
3. Connection—After a device has completed the paging process, it enters the connection state. While connected, a device can either be actively participating or it can be put into a low power sleep mode.

### Bonding and Pairing

When two Bluetooth® devices, such as the A2DP transmitter 203 and A2DP receiver 205, are compatible, they can be bonded together. Bonded devices automatically establish a connection whenever they're close enough. Bonds are created through a one-time process called pairing. When devices pair up, they share their addresses, names, and profiles, and usually store them in memory. They also share a common secret key, which allows them to bond whenever they're together in the future.

Pairing in this method does not require a user validation for connection between A2DP transmitter 203 and A2DP receiver 205. Pairing is a simple click of a button. This is common for devices with no UI, like headsets.

Using New Audio plus Remote Control System (ARCS).

This new unique Audio plus Remote Control System (ARCS) delivers only one audio signal to the receiver. Therefore any speakers 105 or 106 attached to the Receiver Audio channel will all have the same audio with only a monaural sound, and no stereophonic audio can be received.

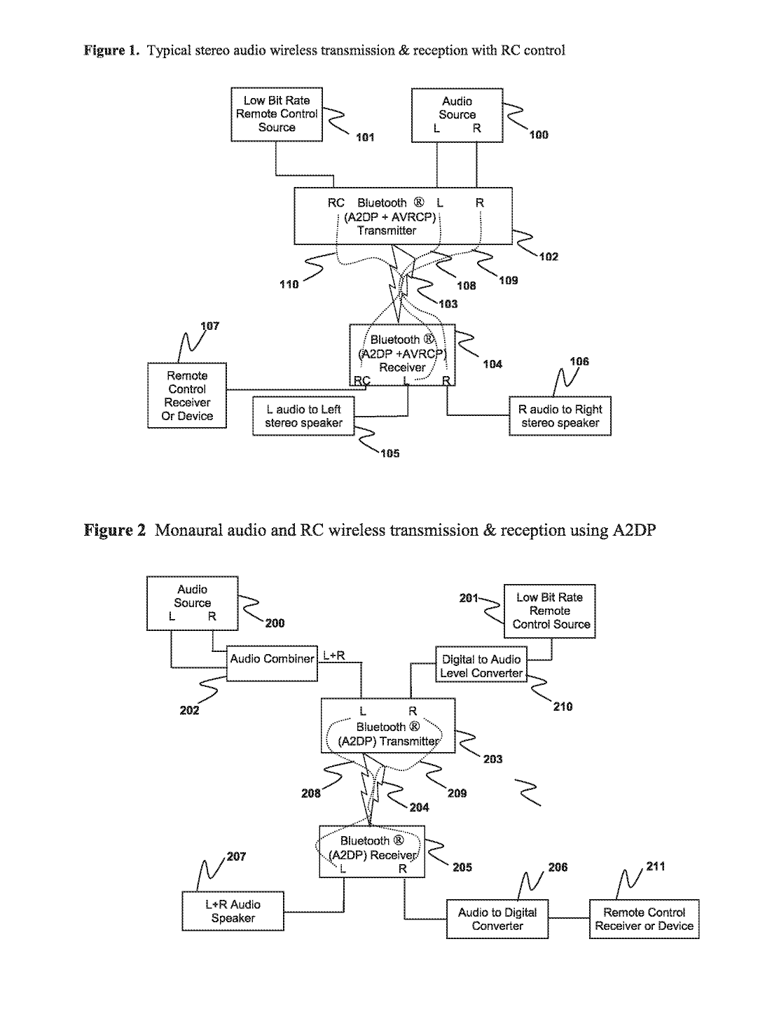

FIG. 1 illustrates the setup of a typical wireless system for transporting stereo audio signals plus a low bit rate remote control signal. The Left and Right audio signals from Audio Source 100 are fed into wireless (A2DP +AVRCP) transmitter 102. The remote control source 101 is also fed into wireless transmitter 102. Wireless transmitter 102 combines the three source signals together for transmission over air link 103 to the wireless receiver 104, which demodulates the signal received over the link. Note that depending on implementation, the combining of the three source signals could be done by multiplexing the source signals and then modulating the multiplexed signal across a single frequency hopped channel, or the separate source signals could each be sent on their own separate frequency hopped channel. After demultiplexing the three transmitted signals 108, 109, 110, the left audio signal 108 is sent to the left speaker 105, the right audio signal 109 is sent to the right speaker 106 and the remote control signal 110 is sent to the remote control receiver 107. Note that this setup requires three logical channels, that may require more than a single frequency hopped channel for transmission:
1. Logical channel 108 to transport the L audio source signal.
2. Logical channel 109 to transport the R audio source signal.
3. Logical channel 110 to transport the remote control signal.

FIG. 2 illustrates the setup of the wireless system for the current invention for transporting audio plus a low bit rate remote control signal. The Left and Right audio signals from Audio Source 200 are fed into audio combiner 202 that adds the L and R audio signals to create the audio signal L+R. The L+R audio signal from audio combiner 202 is fed into wireless (A2DP) transmitter 203 as the left channel. The digital remote control source signals 201 are converted to audio level signals by a digital to audio level converter 210 and are also fed into wireless (A2DP) transmitter 203 as the right channel. Wireless transmitter 203 multiplexes the L+R audio source signal 208 with the remote control source signal 209 and modulates them for transmission over a single frequency hopped channel 204. Bluetooth® A2DP receiver 205 demodulates the signal received over the air and then demultiplexes the audio and remote control signals, sending the L+R audio signal to the speaker 207 and the remote control signal to the audio to digital converter 206. The audio to digital converter 206 restores the digital signal and sends it to the remote control receiver 211. Note that in this setup, only two logical channels and a single frequency hopped channel are required:
1. A logical channel 208 to transport the L+R audio signal.
2. A second logical channel 209 to transport the remote control signal.

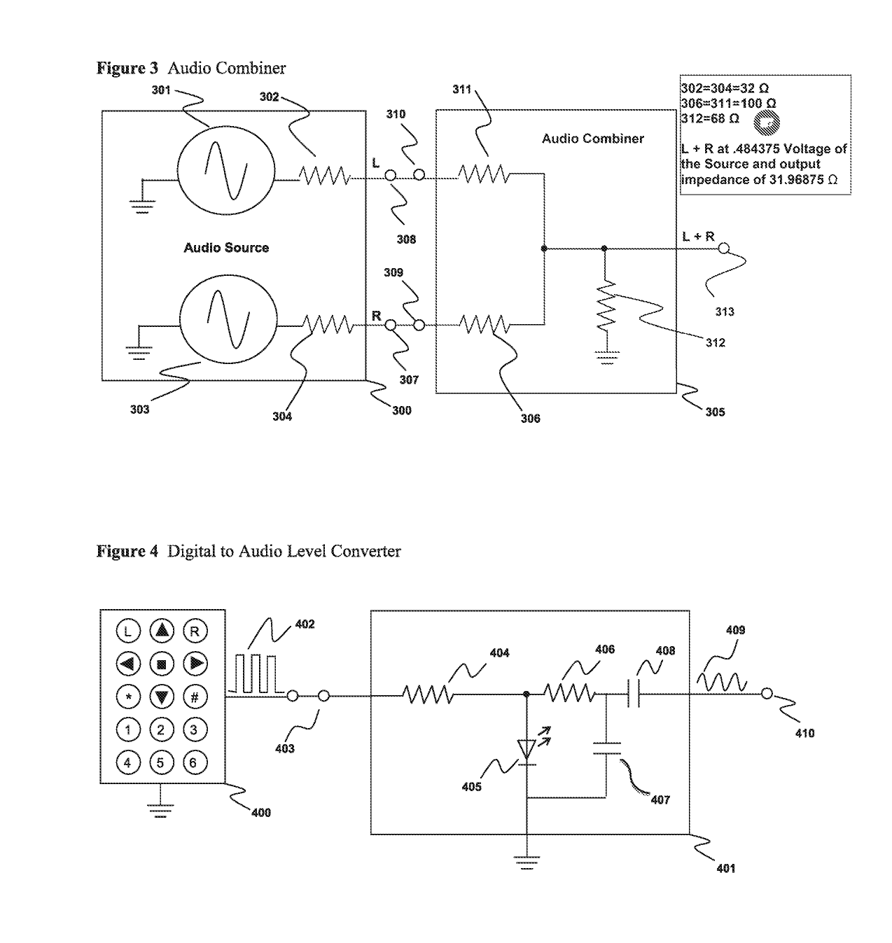

FIG. 3 illustrates details on how left channel 301 and right channel 303 signals from a stereophonic audio source 300 are added in an audio combiner 305 to produce a monaural L+R 313 signal. If the left channel output resistance is, for example, 32 ohms 302, then adding, for example, a 100 ohm resistor 311 by joining points 308 and 310 in series will produce a left channel resistance of 132 ohms. And if the right channel output resistance is, for example, 32 ohms 304 then adding, for example, a 100 ohm resistor 306 by joining points 307 and 309 in series will produce a right channel resistance of 132 ohms. Paralleling these two outputs produces a single output with an internal resistance of 66 ohms. When this 66 ohm output is paralleled by a resistor 312 with a value of, for example, 62 ohms the output resistance appears to be 31.96875 or approximately 32 ohms. Thus maximum power transfer will be provided to a single monaural 32 ohm speaker. Also when both left and right channels 307, 308 are at a peak, the L+R output, 313 will be at 0.484375 of the peak voltages from the two channel outputs 307, 308. In other words the Audio Combiner 305 will produce a L+R signal at approximately half voltage and approximately 32 ohm output resistance. Note that the resistor values discussed above and shown in FIG. 3 were used as examples, but many other resistor values could be used in a similar way to achieve the same result claimed here.

FIG. 4 illustrates details on how signals from any digital source 400 are converted to the proper Bluetooth® audio levels and frequencies by a digital to audio level converter 401. The digital signal 402 from source 400 is connected to the input 403 of the Digital to Audio Level Converter 401. The digital signal 402 passes through resistor 404 and is clamped to a peak to peak level between 1.2 volts and 1.8 volts by LED diode 405. Resistor 406 and capacitor 407 act as a low pass filter to limit the frequency range of the signal 409 at the output 410 of the Digital to Audio Level Converter 401. The capacitor 408 AC couples the signal to the output 410. In this manner the original digital signal 402 is converted to an audio signal 409 of the proper amplitude and frequency range that swings above and below the DC level of the device attached to the output 410.

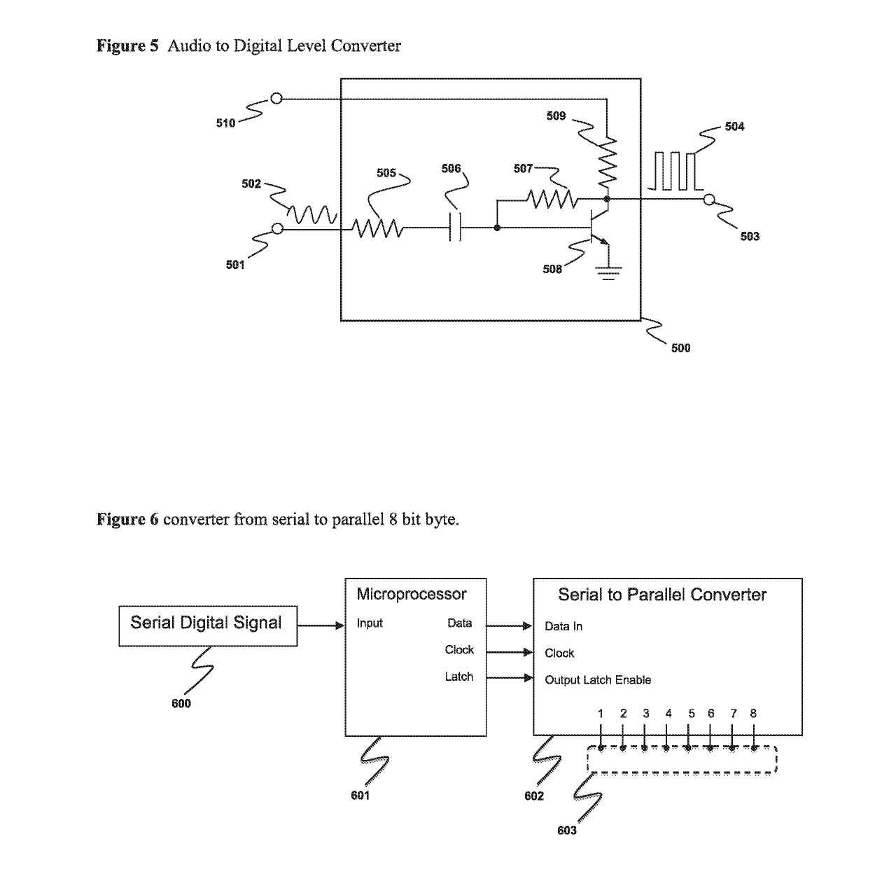

FIG. 5 illustrates details for converting a remote control audio level signal 502 from any audio level output to a digital signal 504. Once digital data is converted to an audio signal and transmitted to a receiving device, it becomes necessary to convert audio signals back to digital signals to recover the data. The Audio to Digital Level Converter 500 circuit takes any audio level signal 502 at it's input 501 and converts it to a digital level signal 504. The transistor 508 is biased to be off but very close to turning on by resistors 507 and 509. In this state the output 503 is at the voltage placed on pin 510. Very small input signals 502 can turn transistor 508 fully on by passing current through resistor 505 and capacitor 506 to the bias point of transistor 508. In the fully on state the output 503 is approximately zero volts. The output signal 504 is now a digital signal with the voltage placed at B+ pin 510 as a high state and near zero as a low state. This allows the voltage placed at the B+ pin 510 to be adjusted to match the required high voltage levels for digital switching or microprocessor inputs. The capacitor 506 blocks DC voltages on the input 501 from locking the transistor 508 in the on or off state. Resistor 505 is required to prevent capacitor 506 from stretching the audio pulses. The time constant of resistor 505 and capacitor 506 should be adjusted to match the baud rate of any desired digital signal.

FIG. 6 illustrates how low bit rate audio signals 502 that have been converted to digital level signals 504, 600 can be stored as a byte of 8 bits 603 with 256 possible different combinations. The Serial Digital Signal 600 is sent to a device similar to a microprocessor 601 which either has parallel outputs or uses a Serial to Parallel Converter 602 to latch the 8 bit byte 603 at its outputs. In this manner, music may be transmitted to a speaker along with and simultaneous to data for a laser display attached to the speaker. The song and display are linked and the display does not have to be created from the music. In this method, however, if the right channel was actually music, it would be converted to a digital signal and then an eight bit byte that could make a random laser display created from the music. This does not limit this device to just a display, the outputs of the Serial to Parallel Converter 602 could also be used to drive wheels of a car, beep the car horn, flash the car headlights, turn on turn signals, open car doors, open car trunk, and many other features all simultaneous and without interference with music coming from the remote controlled car radio.

1) A system for providing a combined left and right audio signal and a remote control function in a two channel stereo system to an electronic device comprising:
providing a left audio signal wherein the left audio signal is one-half of a stereo transmission and wherein the left audio signal occupies a complete channel;
providing a right audio signal wherein the right audio signal is one-half of a stereo transmission wherein the right audio signal occupies a complete channel;
wherein the left audio signal and the right audio signal are both fed into an audio combiner and wherein the audio combiner creates a monaural audio signal frequency utilizing only one channel; and
utilizing the remaining open channel to provide a remote control function to an electronic device.

2) The system for providing a combined left and right audio signal and a remote control function in a two channel stereo system to an electronic device of claim 1 wherein the remaining open channel provides non-audio information to the electronic device.

3) The system for providing a combined left and right audio signal and a remote control function in a two channel stereo system to an electronic device of claim 1 wherein the left audio signal and the right audio signal are parallel after exiting the audio combiner.

4) The system for providing a combined left and right audio signal and a remote control function in a two channel stereo system to an electronic device of claim 1 wherein the monaural audio signal frequency produced by the audio combiner is approximately half voltage of the initial left audio signal or the initial right audio signal.

5) The system for providing a combined left and right audio signal and a remote control function in a two channel stereo system to an electronic device of claim 1 wherein the audio combiner has a first ohm resister which, for example, adds 100 ohm to the left audio signal of approximately 32 ohms and a second ohm resistor which adds 100 ohm to the right audio signal of approximately 32 ohms so that the left audio signal and the right audio signal are added equally.
